(19) United States
(12) Patent Application Publication
(10) Pub. No.: US 2007/0026908 A1
(43) Pub. Date: Feb. 1, 2007

(54) Earphone device with separable wireless transmission module

(75) Inventor: Yen-Feng Chen, Te-Hsing Tsun (TW)

Correspondence Address: BANNER & WITCOFF, 1001 G STREET N W, SUITE 1100, WASHINGTON, DC, 20001, US

(73) Assignee: Universal Scientific Industrial Co., Ltd., Nan-Tou Hsien (TW)

(21) Appl. No.: 11/192,391

(22) Filed: Jul. 29, 2005

(51) Int. Cl. H04B 7/00; H04M 1/00

(52) U.S. Cl. 455/575.2; 455/41.3; 455/41.2; 455/557

(57) ABSTRACT

An earphone device includes an earphone module provided with a first connector, and a wireless transmission module provided with a second connector for mating electrically and removably with the first connector such that the earphone module and the wireless transmission module are interconnected electrically and form a single unit for bi-directional wireless voice transmission with a mobile communications device, such as a personal digital assistant or mobile phone. When removed from the earphone module, the wireless transmission module can be connected electrically to an electronic device, such as a computer or car stereo system, through the second connector so as to provide the electronic device with wireless transmission capability.

### BACKGROUND OF THE INVENTION

1. Field of the Invention

The invention relates to an earphone device having a wireless transmission capability, more particularly to an earphone device having separable earphone and wireless transmission modules.

2. Description of the Related Art

In Taiwanese publication no. 584345, there is disclosed a Bluetooth hands-free modular system that includes a Bluetooth earphone, a base, and an audio output device (such as a set of speakers) coupled to the base through a wired or wireless connection.

When hung on the user's ear, the Bluetooth earphone can cooperate with a Bluetooth mobile phone to commence wireless voice transmission in a privacy mode. In addition, when the Bluetooth earphone is connected to the base, the Bluetooth earphone can cooperate with the Bluetooth mobile phone and the base to commence wireless voice transmission in a hands-free mode, in which voice signals of the other party are reproduced via the audio output device that is coupled to the base. Voice transmission can be switched from the hands-free mode back to the privacy mode by simply disconnecting the Bluetooth earphone from the base and hanging the Bluetooth earphone once again on the user's ear.

The following are some of the drawbacks of the aforesaid conventional Bluetooth hands-free modular system:

1. The specially designed base is a necessary component in order to enable operation of the modular system in the hands-free mode, thus resulting in higher costs. In addition, additional components are required to establish the requisite electrical connections to the base, which results in a larger size and less appealing overall appearance. 2. The Bluetooth earphone is designed solely for wireless voice transmission and not for wireless data transmission.

### SUMMARY OF THE INVENTION

Therefore, the object of the present invention is to provide an earphone device having separable earphone and wireless transmission modules to overcome the aforesaid drawbacks of the prior art.

According to this invention, an earphone device is capable of bi-directional wireless voice transmission with a mobile communications device, and is adapted for use with an electronic device that is provided with an electrical connector. The earphone device comprises an earphone module provided with a first connector, and a wireless transmission module provided with a second connector for mating electrically and removably with the first connector such that the earphone module and the wireless transmission module are interconnected electrically and form a single unit. The second connector of the wireless transmission module is adapted to mate electrically and removably with the electrical connector of the electronic device when removed from the first connector such that the wireless transmission module is connected electrically to the electronic device and provides the electronic device with wireless transmission capability.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view to illustrate a separated state of earphone and wireless transmission modules of the preferred embodiment of an earphone device according to the present invention;

FIG. 2 is a schematic view to illustrate an interconnected state of the earphone and wireless transmission modules of the preferred embodiment;

FIG. 3 is a simplified block diagram to illustrate possible applications of the preferred embodiment;

FIG. 4 is a schematic view of the preferred embodiment when used with a mobile communications device; and

FIG. 5 is a schematic view of the preferred embodiment when used with a mobile communications device and a car stereo system.

### DETAILED DESCRIPTION OF THE PREFERRED EMBODIMENT

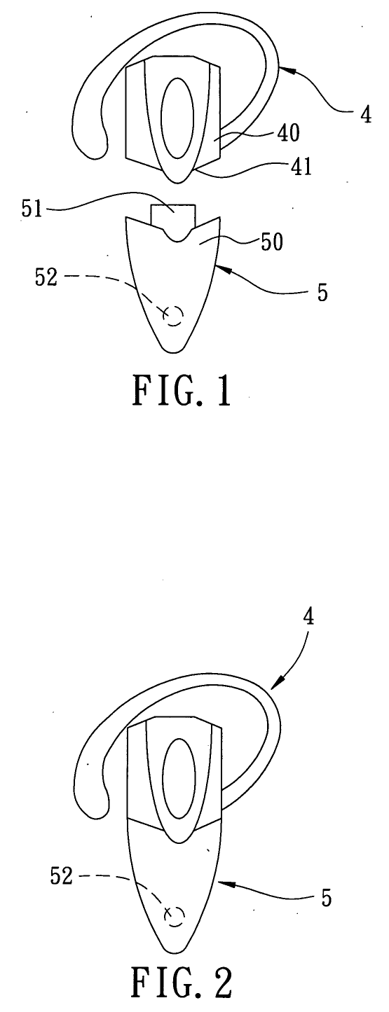

Referring to FIGS. 1 and 2, the preferred embodiment of an earphone device according to the present invention is shown to comprise an earphone module 4 and a wireless transmission module 5.

The earphone module 4 has a first housing 40, is configured for hanging on the user's ear (not shown) and is provided with a first connector 41. In this embodiment, the first connector 41 is a Universal Serial Bus (USB) socket.

The wireless transmission module 5, which supports the Bluetooth wireless transmission standard in this embodiment, has a second housing 50 separate from the first housing 40, and is provided with a second connector 51 and a microphone 52. In this embodiment, the second connector 51 is a USB plug that is capable of mating electrically and removably with the first connector 41 of the earphone module 4 such that the earphone module 4 and the wireless transmission module 5 are interconnected electrically, and such that the first and second housings 40, 50 form a single housing unit, as best shown in FIG. 2.

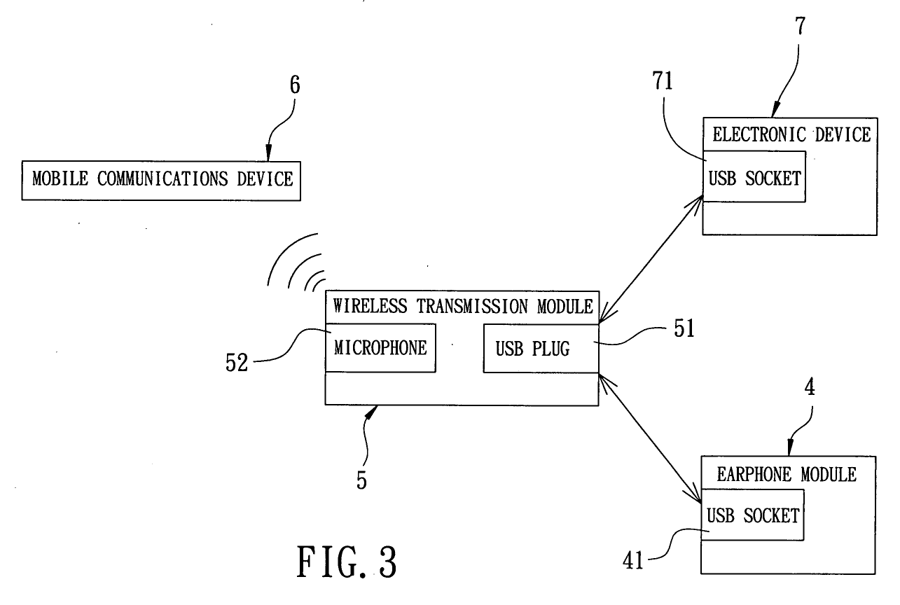

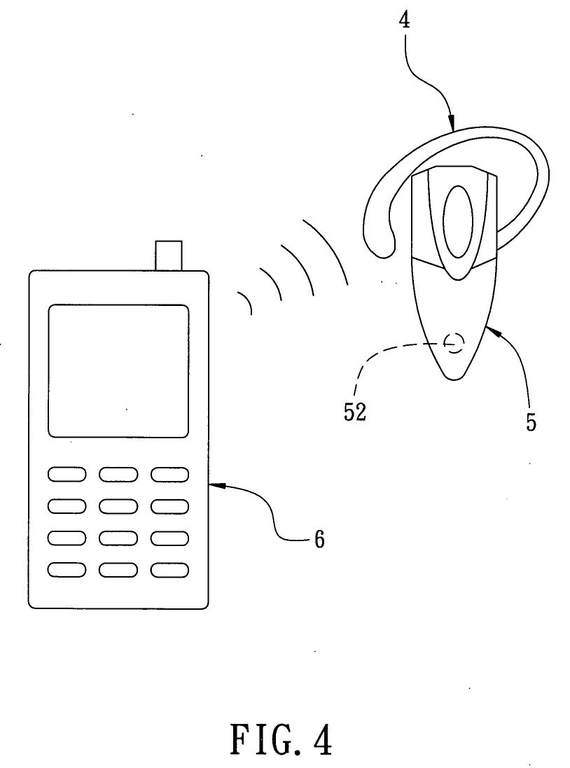

Referring to FIGS. 3 and 4, when the earphone module 4 and the wireless transmission module 5 are interconnected electrically, the earphone device of this invention can be hung on the user's ear (not shown) and subsequently used with a mobile communications device 6, such as a mobile phone or personal digital assistant (PDA) , for bi-directional wireless voice transmission according to the Bluetooth wireless transmission standard in a conventional manner.

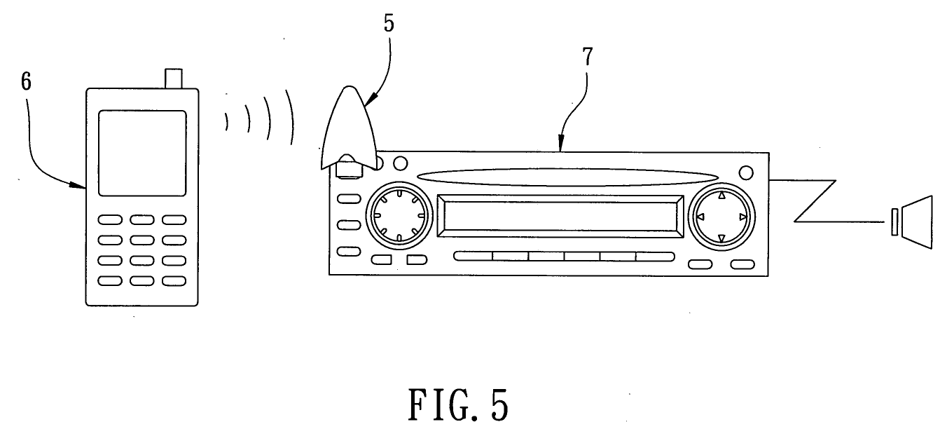

Referring to FIGS. 3 and 5, when the wireless transmission module 5 is disconnected from the earphone module 4, the second connector 51 of the wireless transmission module 5 is configured to mate electrically and removably with a USB socket 71 of an electronic device 7, e.g., a computer or a car stereo system, such that the wireless transmission module 5 is connected electrically to the electronic device 7 and provides the electronic device 7 with wireless transmission capability. In particular, when the wireless transmission module 5 is applied to the car stereo system 7 and is used with a mobile phone 6, not only is it possible to show call information on a display of the car stereo system 7, wireless voice transmission in a hands-free mode can also commence, in which voice signals of the other party are reproduced by car speakers (not shown) connected to the car stereo system 7. Volume control is then possible through control buttons on the car stereo system 7 or through a dedicated set of control buttons on a steering wheel (not shown). It is also possible to recharge the wireless transmission module 5 when the latter is connected to the car stereo system 7.

To switch voice transmission from the hands-free mode back to the privacy mode, the wireless transmission module 5 is simply disconnected from the car stereo system 7 and is connected once again to the earphone module 4, and the earphone device of this invention is hung once more on the user's ear.

When the wireless transmission module 5 is applied to a computer, the computer can conduct wireless data transmission via the wireless transmission module 5 according to the Bluetooth wireless transmission standard in a conventional manner.

The following are some of the advantages of the earphone device of this invention:

1. In view of the separated designs of the earphone module 4 and the wireless transmission module 5, the wireless transmission module 5 can be applied directly to an electronic device 7 to provide the latter with wireless transmission capability. Since there is no need for an additional specially designed base as taught in the aforementioned prior art, lower costs are incurred and a small size can be maintained so as to result in a more appealing overall appearance.

2. The wireless transmission module 5 can be applied to mobile communications devices 6 for wireless voice transmission and to electronic devices 7 for wireless data transmission, thereby resulting in improved functionality as compared to the aforementioned prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An earphone device capable of bi-directional wireless voice transmission with a mobile communications device, and adapted for use with an electronic device that is provided with an electrical connector, said earphone device comprising:
an earphone module provided with a first connector; and
a wireless transmission module provided with a second connector for mating electrically and removably with said first connector such that said earphone module and said wireless transmission module are interconnected electrically and form a single unit;
said second connector of said wireless transmission module being adapted to mate electrically and removably with the electrical connector of the electronic device when removed from said first connector such that said wireless transmission module is connected electrically to the electronic device and provides the electronic device with wireless transmission capability.

2. The earphone device of claim 1, wherein said first connector is a socket, and said second connector is a plug.

3. The earphone device of claim 1, wherein said wireless transmission module supports the Bluetooth wireless transmission standard.

4. The earphone device of claim 1, wherein said wireless transmission module includes a microphone.

5. The earphone device of claim 1, wherein said first and second connectors are complementary Universal Serial Bus (USB) connectors.

6. An earphone device comprising:
an earphone module provided with a first connector; and
a wireless transmission module provided with a second connector for mating electrically and removably with said first connector such that said earphone module and said wireless transmission module are interconnected electrically and form a single unit.

7. The earphone device of claim 6, wherein said first connector is a socket, and said second connector is a plug.

8. The earphone device of claim 6, wherein said wireless transmission module supports the Bluetooth wireless transmission standard.

9. The earphone device of claim 6, wherein said wireless transmission module includes a microphone.

10. The earphone device of claim 6, wherein said first and second connectors are complementary Universal Serial Bus (USB) connectors.

11. An earphone device capable of bi-directional wireless voice transmission with a mobile communications device, and adapted for use with an electronic device that is provided with an electrical connector, said earphone device comprising:
an earphone module having a first housing and provided with a first connector; and
a wireless transmission module having a second housing separate from said first housing and provided with a second connector for mating electrically and removably with said first connector such that said earphone module and said wireless transmission module are interconnected electrically and such that said first and second housings form a single housing unit;
said second connector of said wireless transmission module being adapted to mate electrically and removably with the electrical connector of the electronic device when removed from said first connector such that said wireless transmission module is connected electrically to the electronic device and provides the electronic device with wireless transmission capability.

12. The earphone device of claim 11, wherein said first connector is a socket, and said second connector is a plug.

13. The earphone device of claim 11, wherein said wireless transmission module supports the Bluetooth wireless transmission standard.

14. The earphone device of claim 11, wherein said wireless transmission module includes a microphone.

15. The earphone device of claim 11, wherein said first and second connectors are complementary Universal Serial Bus (USB) connectors.
